(19) United States
(12) Patent Application Publication
(10) Pub. No.: US 2024/0198999 A1
(43) Pub. Date: Jun. 20, 2024

(54) CONTROL DEVICE, POWER CONTROL SYSTEM WITH THE CONTROL DEVICE, AND ELECTRIC ASSIST VEHICLE WITH THE POWER CONTROL SYSTEM

(71) Applicant: FOXCONN INTERCONNECT TECHNOLOGY LIMITED, Grand Cayman (KY)

(72) Inventor: CHIEN-WEN WANG, New Taipei (TW)

(21) Appl. No.: 18/207,641

(22) Filed: Jun. 8, 2023

(30) Foreign Application Priority Data
Dec. 16, 2022 (CN) 202211627874.0

(51) Int. Cl. B60W 20/12

(52) U.S. Cl. CPC B60W 20/12; B60W 2300/36; B60W 2554/4041

(57) ABSTRACT

A control device is provided. The control device includes a positioning unit, a control unit, and a communication unit. The positioning unit can receive satellite signals, and generate position information of the electric assist vehicle according to the satellite signals. The control unit can generate information of reference paths according to the position information of the electric assist vehicle and information of paths. The control unit can control the electric assist vehicle to achieve a corresponding function in response to an operation signal. The communication unit can transmit the information of the reference paths to a power control unit, to inform the power control unit to control a size of an assist power of the electric assist vehicle according to the information of the reference paths. A related power control system and a related electric assist vehicle are provided.

### FIELD

The subject matter herein generally relates to a mobile vehicle technology, and particularly to a control device, a power control system with the control device, and an electric assist vehicle with the power control system.

### BACKGROUND

In general, electric assist vehicles do not have Global Positioning System (GPS) positioning function. To obtain the GPS positioning function, a mobile phone installing an application which has a navigation function or a GPS cycling computer can be employed by a user. However, when the mobile phone is employed, it is inconvenient and maybe illegal to operate the mobile phone during driving. Furthermore, the mobile phone is not fixed to the electric assist vehicle, the position of the mobile phone may change, and the mobile phone may not be able to receive accurate position information. Moreover a power of the mobile phone will be depleted faster when the GPS function is turned on. When the GPS cycling computer is employed, a weight of the electric assist vehicle and a cost of the electric assist vehicle may be increased.

### SUMMARY

An embodiment of the present application provides a control device, a power control system with the control module, and an electric assist vehicle with the power control system which can accurately position a position of the electric assist vehicle, and simultaneously prevent an adding of the mechanism pieces to the electric assist vehicle.

In a first aspect, an embodiment of the present application provides a control device. The control device is installed on an electric assist vehicle. The control device includes a positioning unit, a control unit, and a communication unit. The positioning unit is configured to receive satellite signals, and generate position information of the electric assist vehicle according to the satellite signals. The control unit is configured to generate information of one or more reference paths according to the position information of the electric assist vehicle and information of paths. The control unit is further configured to control the electric assist vehicle to activate a corresponding function in response to an operation signal. The communication unit is configured to transmit the information of the one or more reference paths to a power control unit, and to inform the power control unit to control a size of an assist power of the electric assist vehicle according to the information of the one or more reference paths.

The control device can integrate the positioning unit, the control unit, and the communication unit, thus the control device can automatically obtain the position information of the electric assist vehicle via the positioning unit, and generate the information of the reference paths according to the position information via the control unit, and transmit the information of the reference paths to function device external to the control device via the communication unit. The function device can control the electric assist vehicle according to the information of the reference paths. The control device can further receive the operation signal, generate the function control signal according to the operation signal via the control unit, and transmit the function control signal to the function device external to the control device via the communication unit. Thus, a way for individually performing an intended function of the electric assist vehicle can be provided for the user. After installing the control device of the embodiment, the electric assist vehicle does not need to install the GPS cycling computer or to couple to the mobile phone installing the application which has the negative function. Thus, the number of the mechanism pieces of the electric assist vehicle is reduced, the weight of the electric assist vehicle can be accurately controlled, and the control device can be installed conveniently. Further, a development cost of a mold is lower, and a waterproof level can be improved.

According to some embodiments of the present application, the control device further includes a storage unit. The storage unit is configured to store the information of the paths, the information of the paths comprise information of one or more preset paths or information of one or more paths with a riding number which reaches a preset threshold.

The storage unit is integrated into the control device. The storage unit is configured to store the information of the path, thus the control unit can generate the information of the reference paths according to the position information and the information of the path, and transmit the information of the reference paths to the function device external to the control device. Thus, the user can quickly obtain an appropriate assist power on the path where the user usually rides on or which the user preset.

According to some embodiments of the present application, the control unit is configured to search the storage unit according to the position information of the electric assist vehicle to determine information of one or more target paths, wherein the information of one or more target paths matches the position information of the electric assist vehicle and is in the information of the paths stored in the storage unit. The control unit generates the information of the one or more reference paths according to the position information of the electric assist vehicle and the information of the one or more target paths.

According to some embodiments of the present application, the control device further includes an input unit. The input unit is configured to generate the operation signal in response to an input operation, and transmit the operation signal to the control unit.

The control device can control the function device external to the control device to achieve the corresponding functions of the electric assist vehicle via an operation on the input unit by the user. Thus, a way for individually performing an intended function of the electric assist vehicle can be conveniently provided

According to some embodiments of the present application, the positioning unit is an integration of a global positioning system chip and at least one of a group consisting of a Wireless Fidelity wireless module, a Bluetooth module, and an antenna.

According to some embodiments of the present application, the control device is configured to be installed on a handlebar of the electric assist vehicle.

The control device is installed on the handlebar of the electric assist vehicle, the control device can receive a satellite signal with a higher strength, thus the position information can be accurately generated, and the position of the electric assist vehicle can be accurately position, simultaneously, it is convenient for the user to operate the control device.

In a second aspect, an embodiment of the present application provides a power control system. The power control system includes a power control unit and a control device. The power control unit is electrically coupled to the control device. The control device is installed on a handlebar of an electric assist vehicle. The control device includes a positioning unit, a control unit, and a communication unit. The positioning unit is configured to receive satellite signals, and generate position information of the electric assist vehicle according to the satellite signals. The control unit is configured to generate information of one or more reference paths according to the position information of the electric assist vehicle and information of paths. The control unit is further configured to control the electric assist vehicle to activate a corresponding function in response to an operation signal. The communication unit is configured to transmit the information of the one or more reference paths to the power control unit. The power control unit is configured to control a size of an assist power of the electric assist vehicle according to the information of the one or more reference paths.

When the function device external to the control device is the power control unit, the control device can cooperate with the battery, the motor, and the power control unit of the electric assist vehicle to form the power control system, to achieve an automatic control of the size of the assist power of the electric assist vehicle.

According to some embodiments of the present application, the power control system further comprises a display device, the display device is configured to display the information of the one or more reference paths and preset information, the preset information comprises at least one of a group consisting of personal information of the user, news, and weather.

The information of the reference paths can be visually provided for the user via the display device. Thus, the information of the reference paths is visualization.

According to some embodiments of the present application, the power control system further comprises a mobile terminal, the mobile terminal is configured to display the information of the one or more reference paths, and/or generate navigation information according to the information of the one or more reference paths.

When the mobile terminal is used as the function device external to the control device, the information of the reference paths can be visually provided for the user via the mobile terminal, the information of the reference paths is visualization. Simultaneously, the mobile terminal can feed back the other useful information generated for the user according to the information of the reference paths.

In a third aspect, an embodiment of the present application provides an electric assist vehicle. The electric assist vehicle includes a power control system. The power control system includes a power control unit and a control device. The power control unit is electrically coupled to the control device. The control device is configured to be installed on a handlebar of an electric assist vehicle. The control device includes a positioning unit, a control unit, and a communication unit. The positioning unit is configured to receive satellite signals, and generate position information of the electric assist vehicle according to the satellite signals. The control unit is configured to generate information of one or more reference paths according to the position information of the electric assist vehicle and information of paths. The control unit is further configured to control the electric assist vehicle to activate a corresponding function in response to an operation signal. The communication unit is configured to transmit the information of the one or more reference paths to the power control unit. The power control unit is configured to control a size of an assist power of the electric assist vehicle according to the information of the one or more reference paths.

The disclosure provides the control device, the power control system with the control device, and the electric assist vehicle with the power control system. The control device can integrate the positioning unit, the control unit, and the communication unit, thus the control device can automatically obtain the position information of the electric assist vehicle via the positioning unit, and generate the information of the reference paths according to the position information via the control unit, and transmit the information of the reference paths to function device external to the control device via the communication unit. The function device can control the electric assist vehicle according to the information of the reference paths. The control device can further receive the operation signal, generate the function control signal according to the operation signal via the control unit, and transmit the function control signal to the function device external to the control device via the communication unit. Thus, a way for individually performing an intended function of the electric assist vehicle can be provided for the user. After installing the control device of the embodiment, the electric assist vehicle does not need to install the GPS cycling computer or to couple to the mobile phone installing the application which has the negative function. Thus, the number of the mechanism pieces of the electric assist vehicle is reduced, the weight of the electric assist vehicle can be accurately controlled, and the control device can be installed conveniently. Further, a development cost of a mold is lower, and a waterproof level can be improved.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of an electric assist vehicle.

FIG. 2 is a block diagram of an embodiment of a control device.

FIG. 3 is a schematic view of an embodiment of a casing of a control device.

FIG. 4 is a schematic view of an embodiment of a power control system of an electric assist vehicle.

FIG. 5 is an application scenario view of an embodiment of a control device.

FIG. 6 is an application scenario view of another embodiment of a control device.

### DETAILED DESCRIPTION

For clarity, of illustration of objectives, features and advantages of the present disclosure, the drawings combined with the detailed description illustrate the embodiments of the present disclosure hereinafter. It is noted that embodiments of the present disclosure and features of the embodiments can be combined, when there is no conflict.

Various details are described in the following descriptions for better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments, and are not intended to limit the present disclosure. The term “coupled” in the disclosure includes a wired connection or a wireless connection.

In order to precisely illustrate the technical solutions of the present disclosure, and in order to precisely understand the present disclosure, the term used in the disclosure will be described or defined before illustrating the detail description.

The global positioning system (GPS) is a high-precision radio navigation positioning system based on artificial earth satellites, which can provide accurate geographical position, running speed and accurate time information anywhere in the world and in near-earth space.

The global navigation satellite system (GNSS) refers to all satellite navigation systems, for example, the GPS in the United States, the GLONASS in Russia, the Galileo in Europe, the BEIDOU satellite navigation system in China, and related enhanced systems such as the wide region augmentation system in the United States, the European geostationary navigation overlay service, and the multi-functional satellite augmentation system in Japan. The global navigation satellite system further includes other satellite navigation systems under construction and to be constructed in the future. The international GNSS system is a multi-system, multi-layer, multi-mode complex combination system.

GPS IC is a chip for positioning. GPS IC is configured to receive satellite signals from the GPS and provide position information for the user.

GPS cycling computer is a cycling computer which has a GPS function and a display screen to display navigation information. The GPS cycling computer can be, for example a product such as Rider S500.

Nowadays, electric assist vehicles do not have Global Positioning System (GPS) positioning function. To obtain the GPS positioning function, a mobile phone installing an application which has a navigation function can be coupled to the electric assist vehicle, thus the position information of the electric assist vehicle can be obtained via the GPS positioning function of the mobile phone. Or, to obtain the GPS positioning function, a GPS cycling computer can be individually bought and be installed on the electric assist vehicle by a user, or the electric assist vehicle having the GPS cycling computer can be bought by the user.

The disclosure provides a control device, a power control system with the control device, and an electric assist vehicle with the power control system which can avoid an installing of the GPS cycling computer on the electric assist vehicle or avoid a coupling of the mobile phone installing the application which has the navigation function to the electric assist vehicle, or avoid a buying of the electric assist vehicle which has the GPS cycling computer, thus the number of the mechanism pieces of the electric assist vehicle can be reduced, and a weight of the electric assist vehicle can be accurately controlled.

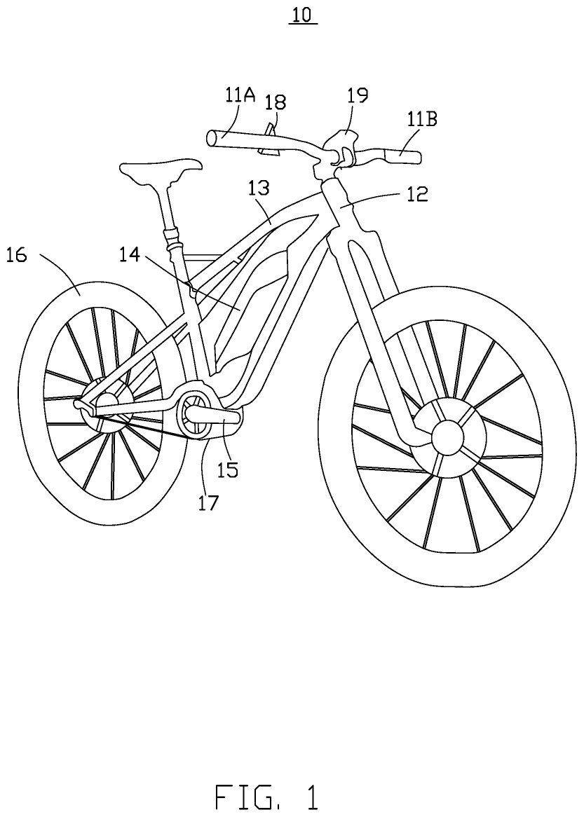

Referring to FIG. 1, FIG. 1 is a schematic view of an embodiment of an electric assist vehicle. The electric assist vehicle 10 includes a first handlebar 11A, a second handlebar 11B, a front frame 12, a vehicle frame 13, and two wheels 16. The first handlebar 11A and the second handlebar 11B are respectively arranged on two ends of the front frame 12 of the electric assist vehicle 10. The electric assist vehicle 10 further includes a battery 14, a motor 15, and a power control unit 17. The battery 14, the motor 15, and the power control unit 17 each is installed on the vehicle frame 13. The battery 14 and the motor 15 each is electrically coupled to the power control unit 17. The motor 15 is configured to convert an electric power of the battery 14 to a mechanical power, to drive the wheels 16 of the electric assist vehicle 10 to rotate, thereby driving the electric assist vehicle 10 to move. The power control unit 17 is configured to control a size of the mechanical power outputted by the motor 15 according to a received signal.

The electric assist vehicle 10 further includes a control device 18. The control device 18 can be installed on a position of the electric assist vehicle 10, for example the front frame 12, the vehicle frame 13, the first handlebar 11A, the second handlebar 11B, or the like. The control device 18 can be coupled to function devices on the electric assist vehicle 10 via a wired connection or a wireless connection. The function devices can be devices external to the control device 18, fox example a transmission, a vehicle lamp, a display device, the power control unit 17, and so on. A driving manner of the electric assist vehicle 10 includes three manners, respectively a hybrid of a manpower driving and an electric driving, a manpower driving, and an electric driving. The electric assist vehicle 10 can be two-wheelers, three-wheelers, or the like. The electric assist vehicle 10 can be an electric assist bicycle, an electric assist tricycle, or the like. For the convenience of description, the electric assist bicycle with two-wheelers can be used as an example to illustrate the electric assist vehicle 10.

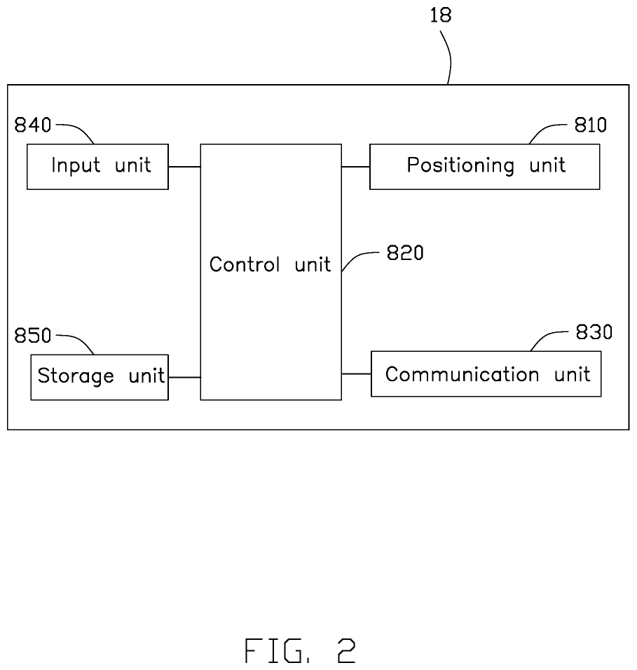

Referring also to FIG. 2, FIG. 2 is a block diagram of an embodiment of a control device 18. The control device 18 includes a positioning unit 810, a control unit 820, and a communication unit 830. The positioning unit 810 is electrically coupled to the control unit 820. The control unit 820 is electrically coupled to the communication unit 830.

The positioning unit 810 can include a positioning RFIC. In some embodiments, the GPS IC and the module having a radio frequency function can be integrated into the positioning RFIC. For example, the GPS IC can integrate with a Wireless Fidelity (WiFi) wireless module or a Bluetooth module to be the positioning RFIC. In some embodiments, the GPS IC and an antenna can be integrated into the positioning unit 810. In detail, after the WiFi wireless module, the Bluetooth module, or the antenna receives the satellite signals, the WiFi wireless module, the Bluetooth module, or the antenna can transmit the satellite signals to the GPS IC. The GPS IC can generate the position information according to the satellite signals. In some embodiments, the positioning unit 810 is configured to receive the satellite signals from the GNSS, generate the position information according to the satellite signals, and transmit the position information to the control unit 820. The position information includes a current geographical position of the electric assist bicycle. It can be understood that, the position information can further include the other information, for example, a surrounding geographic context of the current geographical position of the electric assist bicycle, and so on, the disclosure is not limited herein.

In some embodiments, the control unit 820 can be a microcontroller unit (MCU), or a Central Process Unit (CPU). The control unit 820 is a control center of the control device 18. The control unit 820 can generate a corresponding function control signal in response to an operation signal, so as to activate various functions of the electric assist vehicle 10. The control unit 820 can receive the position information from the positioning unit 810, and generate information of reference paths according to the position information. The information of the reference paths includes one or more reference paths and road section information regarding the road section constituting the reference paths. The road section information can include at least one of a slop uphill section, a slop downhill section, a lane, and so on. Each reference path can include the position information and the path. The reference paths can be one or more paths each including the position information. It can be understood that, each reference path can include the position information and the road section information where the position information is located, the disclosure is not limited herein. The operation signal can be a signal generated via an operation on the electric assist bicycle by a user. For example, when the user starts the electric assist vehicle 10, the control unit 820 can receive an operation signal of starting the electric assist vehicle 10. For example, when the user presets that the vehicle lamp of the electric assist vehicle 10 lights at a preset time, the control unit 820 can receive an operation signal of lighting the vehicle lamp of the electric assist vehicle 10 when the preset time arrives. Each function control signal corresponds to one operation signal. The function control signal includes a signal of starting the control device 18, a signal of adjusting a light mode of the vehicle lamp, a signal of increasing the assist power of the electric assist vehicle 10, a signal of reducing the assist power of the electric assist vehicle 10, and so on. The generating the information of the reference paths according to the positioning information includes that, the control unit 820 can download the path information from the cloud or read the path information from the storage unit after the control unit 820 receives the positioning information, and generate the information of the reference paths according to the position information and the information of the paths. The information of the reference paths can include a number of paths from the current position of the electric assist vehicle 10 to a destination. The information of the reference paths can be information of a best path in all the paths. The best path can be preset. For example, the best path can be a path in minimum time among a number of paths from the current position of the electric assist vehicle 10 to the destination, a path with minimum traffic lights among a number of paths from the current position of the electric assist vehicle 10 to the destination, or a path riding usual by a rider, namely a path with a riding number which reaches a preset threshold. It can be understood that, the information of the reference paths can further include one or more paths from a certain point to the destination, the disclosure is not limited herein.

The communication unit 830 can be a wireless communication unit. For example, the communication unit 830 can be a Bluetooth module, a ZigBee Technology module, an advanced network tools (ANT+), an Ultra Wide Band (UWB), or a Near Field Communication (NFC). The communication unit 830 can further be a ControLLer Area Net-work Bus (CANBus). The communication unit 830 can be coupled to the function devices on the electric assist vehicle 10 via the CAN interface and the physical wire. The communication unit 830 is configured to receive a first signal from the control unit 820, and transmit the first signal to the function devices external to the control device 18. In some embodiments, the communication unit 830 is configured to transmit the function control signal generated by the control unit 820 and the information of the reference paths to the function devices. The communication unit 830 is further configured to receive a second signal from the function devices, and transmit the second signal to the control unit 820.

In an application scenario of the control device 18, after the electric assist vehicle 10 is started, the positioning unit 810 of the control device 18 receives the satellite signals, and generates the position information according to the satellite signals. The positioning unit 810 transmits the position information to the control unit 820. The control unit 820 generates the information of the reference paths from the current position of the electric assist vehicle 10 to the destination according to the position information. The control unit 820 further transmits the information of the reference paths to the power control unit 17 via the communication unit 830. The information of the reference paths includes that the electric assist vehicle 10 is on a certain slope uphill section. The power control unit 17 receives the information of the reference paths, and controls the motor 15 to increase the output power according to a preset determining condition and the information of the reference paths, to provide an assist power for the user. And, when a certain preset time arrives, the control unit 820 can receive the operation signal of lighting the vehicle lamp of the electric assist vehicle 10. The control unit 820 can generate a function control signal of lighting the vehicle lamp of the electric assist vehicle 10 according to the operation signal of lighting the vehicle lamp of the electric assist vehicle 10, and further transmit the function control signal to the vehicle lamp. Thus, the vehicle lamp can light according to the function control signal.

It can be understood that, the control device 18 can integrate the positioning unit 810, the control unit 820, and the communication unit 830, thus the control device 18 can automatically obtain the position information of the electric assist vehicle 10 via the positioning unit 810, and generate the information of the reference paths according to the position information via the control unit 820, and transmit the information of the reference paths to function device external to the control device 18 via the communication unit 830. The function device can control the electric assist vehicle 10 according to the information of the reference paths. The control device 18 can further receive the operation signal, generate the function control signal according to the operation signal via the control unit 820, and transmit the function control signal to the function device external to the control device 18 via the communication unit 830. Thus, a way for individually performing an intended function of the electric assist vehicle 10 can be provided for the user. After installing the control device 18 of the embodiment, the electric assist vehicle 10 does not need to install the GPS cycling computer or to couple to the mobile phone installing the application which has the negative function. Thus, the number of the mechanism pieces of the electric assist vehicle 10 is reduced, the weight of the electric assist vehicle 10 can be accurately controlled, and the control device 18 can be installed conveniently. Further, a development cost of a mold is lower, and a waterproof level can be improved.

In some embodiments, the control device 18 further includes an input unit 840. The input unit 840 is electrically coupled to the control unit 820. The input unit 840 can include one or more physical buttons and/or a touch panel. Each button can be a resistive button, a capacitive button, an electromagnetic button, an optical button, or the like. The user can operate the physical buttons and/or virtual buttons of the touch panel to achieve a function of adjusting the size of the assist power of the electric assist vehicle 10, and the other functions of the electric assist vehicle 10. Namely, the user can operate the input unit 840 to control the control unit 820 to generate the function control signal.

It can be understood that, the control device 18 can control the function device external to the control device 18 to activate the corresponding functions of the electric assist vehicle 10 via an operation on the input unit 840 by the user. Thus, a way for individually performing an intended function of the electric assist vehicle 10 can be conveniently provided.

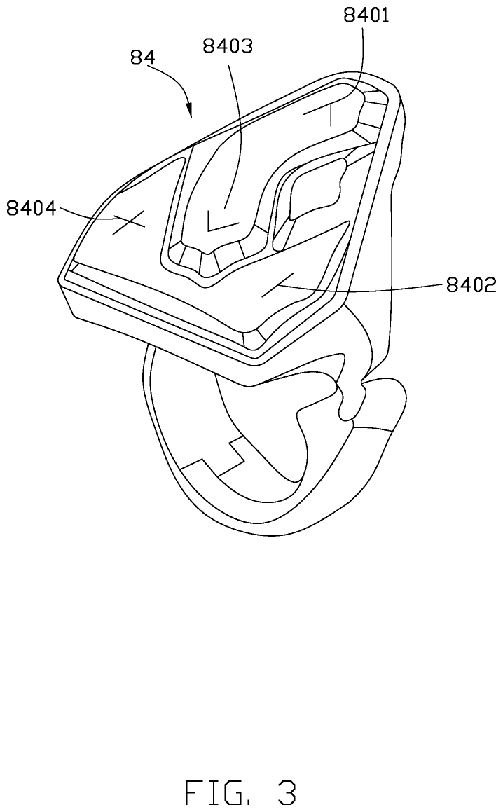

In some embodiments, referring also to FIG. 3, FIG. 3 is a schematic view of an embodiment of a casing 84 of a control device 18. One or more buttons of the input unit 840 are installed on the casing 84 of the control device 18. For example, a first button 8401, a second button 8402, a third button 8403, and a fourth button 8404 are installed on the casing 84. The first button 8401 and the second button 8402 each is configured to adjust the assist power provided by the power control unit 17. For example, when the first button 8401 is pressed, the input unit 840 can generate a first operation signal according to the operation of pressing the first button 8401. The first operation signal can be an operation signal of pressing the first button 8401. The control unit 820 can receive the first operation signal, and generate a first function control signal according to the first operation signal. The first function control signal can be the function control signal of increasing the assist power. The control unit 820 further transmits the first function control signal to the power control unit 17. The power control unit 17 can control the motor 15 to increase the output assist power according to the first function control signal. For example, when the second button 8402 is pressed, the input unit 840 can generate a second operation signal according to the operation of pressing the second button 8402. The second operation signal can be an operation signal of pressing the second button 8402. The control unit 820 can receive the second operation signal, and generate a second function control signal according to the second operation signal. The second function control signal can be the function control signal of decreasing the assist power. The control unit 820 further transmits the second function control signal to the power control unit 17. The power control unit 17 can control the motor 15 to decrease the output assist power according to the second function control signal. The third button 8403 is configured to trigger an adjusting of a light mode of the electric assist vehicle 10, thus an on or an off of the vehicle lamps respectively at the front and at the rear can be adjusted, and a brightness of the vehicle lamps respectively at the front and at the rear can be adjusted. It can be understood that, the position of the vehicle lamps can be varied, the disclosure is not limited herein. The fourth button 8404 is configured to trigger a switching of a display interface of the display device. The display device can include a cycling computer, a mobile phone, and so on. A lower end of the casing 84 includes a round hoop. The round hoop is configured to install the control device 18 to the electric assist vehicle 10. It can be understood that, FIG. 3 is a illustrating of the casing 84, the casing 84 can have other shape; the number of the buttons and the function of the buttons can be varied, the disclosure is not limited herein.

In an application scenario of the control device 18, the control unit 820 can generate information of the reference paths according to the position information of the electric assist vehicle, and transmit the information of the reference paths to the power control unit 17 via the communication unit 830. The power control unit 17 can control the motor 15 to increasing the output power according to the information of the reference paths and the preset determining condition, to provide the assist power for the user. The preset determining condition can be preset by developer or by the user. The preset determining condition can be that, for example, when the position of the electric assist vehicle 10 is on the slope uphill section in the information of the reference paths, the power control unit 17 controls the motor 15 to increasing the output power. The preset determining condition can also be that, for example, when the position of the electric assist vehicle 10 is on the slope downhill section in the information of the reference paths, the power control unit 17 controls the motor 15 to reduce the output power. The user can further operate the input unit 840 of the control device 18 to further increase the output power of the motor 15. In detail, after the user operates the first button 8401 of the input unit 840, the control unit 820 can receive the operation signal of operating the first button 8401 of the input unit 840. The control unit 820 can further generate a function control signal of increasing the assist power according to the operation signal of operating the first button 8401 of the input unit 840, and transmit the function control signal of increasing the assist power to the power control unit 17. The power control unit 17 can further increase the output assist power according to the function control signal of increasing the assist power.

In some embodiments, referring back to FIGS. 1-2, the control device 18 further includes a storage unit 850. The storage unit 850 is electrically coupled to the control unit 820. The storage unit 850 can be a Random Access Memory (RAM), a Read-Only Memory (ROM), a Flash EEPROM Memory (Flash), or the like. The storage unit 850 stores information of paths. The information of paths includes the paths and road section information regarding the road section constituting each path. The paths include one or more paths that the user regularly ride or one or more paths preset by the user. The road section information can include at least one of the slope uphill section, a slope downhill section, a lane, and so on. The road section information further includes position information of the road section. In detail, when the number that the user rides the electric assist vehicle 10 on a certain path reaches a preset threshold, the control unit 820 can record the information of the path, and store the information of the path to the storage unit 850. And the next time the user rides the same path, when the control unit 820 determines that the electric assist vehicle 10 is on a starting point of the information of one or more paths according to the position information of the positioning unit 810, the control unit 820 can directly read the information of the one or more paths from the storage unit 850, generate the information of the reference paths, and transmit the information of the reference paths to the function device external to the control device 18.

In an application scenario of the control device 18, after the electric assist vehicle 10 is started, the positioning unit 810 of the control device 18 transmits the position information of the electric assist vehicle 10 to the control unit 820. The control unit 820 searches the storage unit 850 according to the position information of the electric assist vehicle to determine information of the one or more target paths matches the position information of the electric assist vehicle. In detail, the control unit 820 searches the storage unit 850 according to the position information of the electric assist vehicle to determine the information of the one or more target paths from the information of the paths stored in the storage unit, the position information of the one or more target paths include the position information of the electric assist vehicle. For example, the control unit 820 searches the storage unit 850 according to the position information of the electric assist vehicle to determine that the position information is a starting point of a certain path of the paths stored in the storage unit 850. The control unit 820 further reads the certain path from the storage unit 850, and generates the information of the reference paths according to the position information of the electric assist vehicle and the certain path. The control unit 820 further transmits the information of the reference paths to the power control unit 17. The power control unit 17 can control the motor 15 to increase the output power according to the preset determining condition after receiving the information of the reference paths, to provide the assist power for the user. It can be understood that, during searching the storage unit 850, the position information can also be starting points of some paths, the disclosure is not limited herein.

It can be understood that, the storage unit 850 is integrated into the control device 18. The storage unit 850 is configured for the control unit 820 storing and reading the information of the path, thus the control unit 820 can generate the information of the reference paths according to the position information and the information of the path, and transmit the information of the reference paths to the function device external to the control device 18. Thus, the user can quickly obtain an appropriate assist power on the path where the user usually rides on or which the user preset.

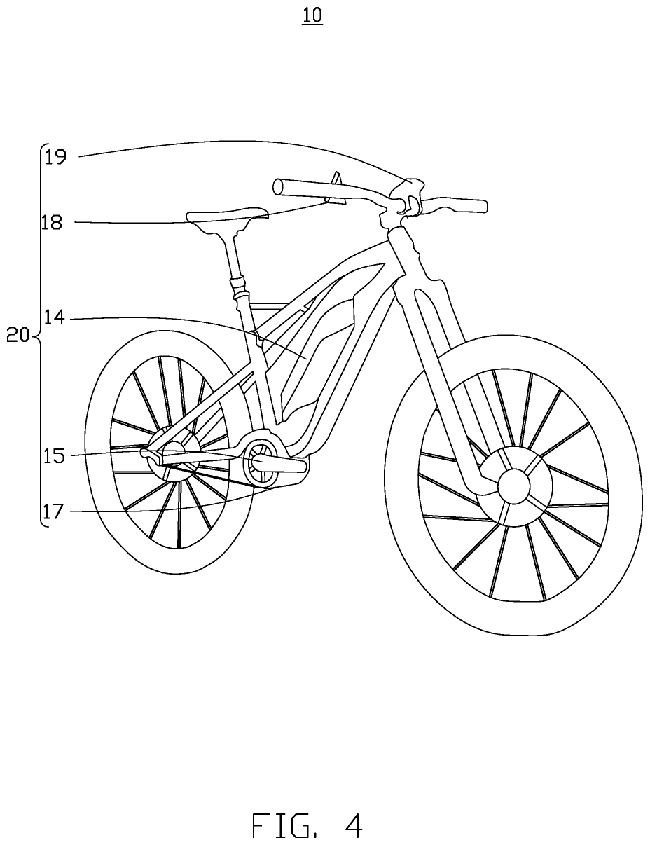

Referring to FIGS. 1 and 4, FIG. 4 is a schematic view of an embodiment of a power control system of an electric assist vehicle 10. The power control system 20 includes a battery 14, a motor 15, a power control unit 17, and a control device 18. In detail, the battery 14 and the motor 15 each is electrically coupled to the power control unit 17. The motor 15 is configured to convert an electric power of the battery 14 to the mechanical power, to drive the wheels 16 of the electric assist vehicle 10 to rotate, thereby driving the electric assist vehicle 10 to move. The power control unit 17 is electrically coupled to the control device 18. The power control unit 17 is configured to receive the function control signal and/or the information of the reference paths transmitted by the control device 18, and control the size of the mechanical power outputted by the motor 15 according to the function control signal and/or the information of the reference paths, thus the size of the assist power can be controlled.

It can be understood that, when the function device external to the control device 18 is the power control unit 17, the control device 18 can cooperate with the battery 14, the motor 15, and the power control unit 17 of the electric assist vehicle 10 to form the power control system 20, to achieve an automatic control of the size of the assist power of the electric assist vehicle 10.

In some embodiments, the power control system 20 can be installed on the electric assist vehicle 10. The battery 14, the motor 15, and the power control unit 17 of the power control system 20 are installed on the vehicle frame 13. The control device 18 can be installed on any position of the electric assist vehicle 10, for example, the front frame 12, the vehicle frame 13, the first handlebar 11A, or the second handlebar 11B.

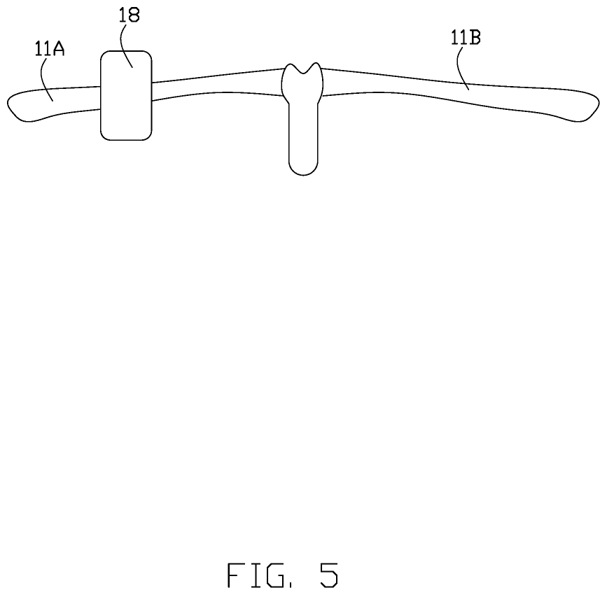

Referring also to FIG. 5, FIG. 5 is an application scenario view of an embodiment of a control device. The control device 18 is installed on the handlebar. When the number of the control device 18 is one, the control device 18 can be installed on the first handlebar 11A or the second handlebar 11B. When the number of the control device 18 is many, for example two, the control device 18 can be respectively installed on the first handlebar 11A and the second handlebar 11B.

It can be understood that, when the mobile phone is employed to position, the mobile phone is not fixed to the electric assist vehicle 10, the position of the mobile phone is changed during riding, thus a strength of the received satellite signals and an accuracy of the positioning can be influenced. Simultaneously, when the mobile phone is employed to position, it is inconvenient to ride. In the disclosure, the control device 18 is installed on the handlebar of the electric assist vehicle 10, the control device 18 can receive satellite signals with a higher strength, thus the position information can be accurately generated, and the position of the electric assist vehicle 10 can be accurately position, simultaneously, it is convenient for the user to operate the control device 18.

In some embodiments, referring back to FIGS. 2 and 4, the power control system 20 further includes a display device 19. The display device 19 can include at least one of a digital display and a mobile terminal. The control unit 820 can transmit the information of the reference paths to the display device 19. The display device 19 can display the information of the reference paths. The display device 19 can display preset information simultaneously. The preset information can include personal information of the user, news, a weather, and so on.

It can be understood that, the information of the reference paths can be visually provided for the user via the display device 19. Thus, the information of the reference paths is visualization.

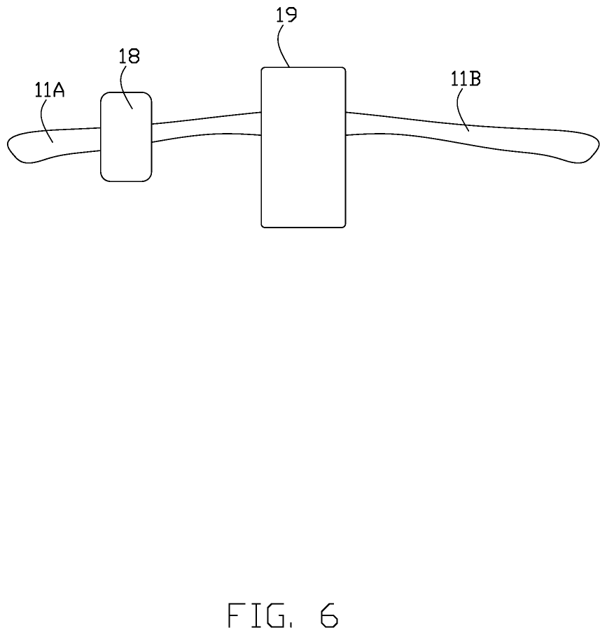

In some embodiments, referring also to FIG. 6, FIG. 6 is an application scenario view of another embodiment of a control device 18. The display device 19 can be installed on a center of the first handlebar 11A and the second handlebar 11B, for the user to know a related information.

In some embodiments, the display device 19 can be the digital display. The control unit 820 can transmit the information of the reference paths to the digital display. The digital display can display the information of the reference paths for the user. The digital display can display the preset information simultaneously. The preset information can include personal information of the user, news, a weather, and so on.

It can be understood that, the information of the reference paths can be visually provided for the user via the digital display. Thus, the information of the reference paths is visualization.

In some embodiments, the battery 14, the motor 15, the power control unit 17, the control device 18, and the digital display can cooperate to form the power control system 20 of the electric assist vehicle 10. The digital display is configured to display the information of the reference paths transmitted by the control device 18 for the user, and transmit the information of the reference paths to the power control unit 17. The power control unit 17 can control the size of the mechanical power outputted by the motor 15 according to the function control signal transmitted from the control device 18 and/or the information of the reference paths transmitted from the digital device, thus the size of the assist power can be controlled.

It can be understood that, the control device 18 can cooperate with the battery 14, the motor 15, the power control unit 17, and the digital display of the electric assist vehicle 10 to form the power control system 20. The power control system 20 can realize an automatic control of the size of the assist power of the electric assist vehicle 10, and a visualization information of the reference paths via the digital display.

In some embodiments, the display device 19 includes a mobile terminal. The mobile terminal can be, for example a mobile phone. The mobile phone can install the application which can display and use the information of the reference paths. When the mobile phone is coupled to the control device 18, the mobile phone can display the information of the reference paths transmitted by the control unit 820 via the application. The mobile phone can further integrate the information of the reference paths to generate a navigation information with a more inclusive content. For example, the mobile phone can prompt the user to accelerate or slow down during riding on a certain section according to the information of the reference paths and the road condition of the reference paths.

It can be understood that, when the mobile terminal is used as the function device external to the control device 18, the information of the reference paths can be visually provided for the user via the mobile terminal, the information of the reference paths is visualization. Simultaneously, the mobile terminal can feed back the other useful information generated for the user according to the information of the reference paths.

A person of ordinary skill in the art may be aware that, in combination with the examples described in the embodiments disclosed in this specification, units and algorithm steps can be implemented by electronic hardware or a combination of computer software and electronic hardware. Whether the functions are performed by the hardware or the software depends on particular applications and design constraint conditions of the technical solutions. A person skilled in the art may use different methods to implement the described functions for each particular application, but it should not be considered that the implementation goes beyond the scope of this application. A person skilled in the art may clearly understand that, for the purpose of convenient and brief description, for a detailed working process of the system and apparatus described above, refer to a corresponding process in the foregoing method embodiments, and details are not described herein again. In the several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms. The units described as separate parts may or may not be physically separate, and parts displayed as units may or may not be physical units, may be located in one location, or may be distributed on a plurality of network units. Some or all of the units may be selected based on an actual requirement to achieve the objectives of the solutions in the embodiments. In addition, functional units in the embodiments of this application may be integrated into one processing unit, or each of the units may exist alone physically, or two or more units are integrated into one unit. It should be noted that, the above are only preferred embodiments and applied technical principles of the present disclosure. Those skilled in the art should understand that, the present disclosure is not limited to the specific embodiments described herein, and various obvious changes, readjustments and substitutions that are made by those skilled in the art will not depart from the scope of the present disclosure. Therefore, although the present disclosure has been described in detail by the above embodiments, the present disclosure is not limited to the above embodiments, and more other equivalent embodiments may be included without departing from the concept of the present disclosure, and the scope of the present disclosure is determined by the scope of the appended claims.

What is claimed is:

1. A control device configured to be installed on an electric assist vehicle,
the control device comprises a positioning unit, a control unit, and a communication unit, wherein
the positioning unit is configured to receive satellite signals, and generate position information of the electric assist vehicle according to the satellite signals;
the control unit is configured to generate information of one or more reference paths according to the position information of the electric assist vehicle and information of paths;
the control unit is further configured to control the electric assist vehicle to activate a corresponding function in response to an operation signal;
the communication unit is configured to transmit the information of the one or more reference paths to a power control unit, and to inform the power control unit to control a size of an assist power of the electric assist vehicle according to the information of the one or more reference paths.

2. The control device according to claim 1, wherein:
the control device further comprises a storage unit, the storage unit is configured to store the information of the paths, the information of the paths comprise information of one or more preset paths or information of one or more paths with a riding number which reaches a preset threshold.

3. The control device according to claim 2, wherein:
the control unit is further configured to search the storage unit according to the position information of the electric assist vehicle to determine information of one or more target paths, wherein the information of the one or more target paths matches the position information of the electric assist vehicle and is in the information of the paths stored in the storage unit; and
the control unit further generates the information of the one or more reference paths according to the position information of the electric assist vehicle and the information of the one or more target paths.

4. The control device according to claim 1 further comprises an input unit, wherein the input unit is configured to generate the operation signal in response to an input operation, and transmit the operation signal to the control unit.

5. The control device according to claim 1, wherein:
the positioning unit is an integration of a global positioning system chip and at least one of a group consisting of a Wireless Fidelity wireless module, a Bluetooth module, and an antenna.

6. The control device according to claim 1, wherein:
the control device is configured to be installed on a handlebar of the electric assist vehicle.

7. A power control system comprising a power control unit and a control device, the power control unit being electrically coupled to the control device, the control device being configured to be installed on a handlebar of an electric assist vehicle, wherein:
the control device comprises a positioning unit, a control unit, and a communication unit;
the positioning unit is configured to receive satellite signals, and generate position information of the electric assist vehicle according to the satellite signals;
the control unit is configured to generate information of one or more reference paths according to the position information of the electric assist vehicle and information of paths;
the control unit is further configured to control the electric assist vehicle to activate a corresponding function in response to an operation signal;
the communication unit is configured to transmit the information of the one or more reference paths to the power control unit;
the power control unit is configured to control a size of an assist power of the electric assist vehicle according to the information of the one or more reference paths.

8. The power control system according to claim 7, wherein:
the control device further comprises a storage unit, the storage unit is configured to store the information of the paths, the information of the paths comprise information of one or more preset paths or information of one or more paths with a riding number which reaches a preset threshold.

9. The power control system according to claim 8, wherein:
the control unit is further configured to search the storage unit according to the position information of the electric assist vehicle to determine information of one or more target paths, wherein the information of the one or more target paths matches the position information of the electric assist vehicle and is in the information of the paths stored in the storage unit; and
the control unit further generates the information of the one or more reference paths according to the position information of the electric assist vehicle and the information of the one or more target paths.

10. The power control system according to claim 9, wherein:
the control device further comprises an input unit, the input unit is configured to generate the operation signal in response to an input operation, and transmit the operation signal to the control unit.

11. The power control system according to claim 7, wherein:
the positioning unit is an integration of a global positioning system chip and at least one of a group consisting of a Wireless Fidelity wireless module, a Bluetooth module, and an antenna.

12. The power control system according to claim 7, wherein:
the power control system further comprises a display device, the display device is configured to display the information of the one or more reference paths and preset information, the preset information comprises at least one of a group consisting of personal information of the user, news, and weather.

13. The power control system according to claim 7, wherein:
the power control system further comprises a mobile terminal, the mobile terminal is configured to display the information of the one or more reference paths, and/or generate a navigation information according to the information of the one or more reference paths.

14. An electric assist vehicle comprising a power control system, the power control system comprising a power control unit and a control device, the power control unit being electrically coupled to the control device, the control device being configured to be installed on a handlebar of an electric assist vehicle, wherein:
the control device comprises a positioning unit, a control unit, and a communication unit;
the positioning unit is configured to receive satellite signals, and generate position information of the electric assist vehicle according to the satellite signals;
the control unit is configured to generate information of one or more reference paths according to the position information of the electric assist vehicle and information of paths;
the control unit is further configured to control the electric assist vehicle to activate a corresponding function in response to an operation signal;
the communication unit is configured to transmit the information of the one or more reference paths to the power control unit;
the power control unit is configured to control a size of an assist power of the electric assist vehicle according to the information of the one or more reference paths.

15. The electric assist vehicle according to claim 14, wherein:
the control device further comprises a storage unit, the storage unit is configured to store the information of the paths, the information of the paths comprise information of one or more preset paths or information of one or more paths with a riding number which reaches a preset threshold.

16. The electric assist vehicle according to claim 15, wherein:
the control unit is further configured to search the storage unit according to the position information of the electric assist vehicle to determine information of one or more target paths, wherein the information of the one or more target paths matches the position information of the electric assist vehicle and is in the information of the paths stored in the storage unit;
the control unit further generates the information of the one or more reference paths according to the position information of the electric assist vehicle and the information of the one or more target paths.

17. The electric assist vehicle according to claim 16, wherein:
the control device further comprises an input unit, the input unit is configured to generate the operation signal in response to an input operation, and transmit the operation signal to the control unit.

18. The electric assist vehicle according to claim 14, wherein:
the positioning unit is an integration of a global positioning system chip and at least one of a group consisting of a Wireless Fidelity wireless module, a Bluetooth module, and an antenna.

19. The electric assist vehicle according to claim 14, wherein:
the power control system further comprises a display device, the display device is configured to display the information of the one or more reference paths and preset information, the preset information comprises at least one of a group consisting of personal information of the user, news, and a weather.

20. The electric assist vehicle according to claim 14, wherein:
the power control system further comprises a mobile terminal, the mobile terminal is configured to display the information of the one or more reference paths, and/or generate navigation information according to the information of the one or more reference paths.
